(19) United States
(12) Patent Application Publication
(10) Pub. No.: US 2024/0245056 A1
(43) Pub. Date: Jul. 25, 2024

(54) STABILIZED BIOFUNGICIDE COMPOSITION COMBINED WITH SYNTHETIC PESTICIDES

(71) Applicant: DPH BIOLOGICALS, LLC, Princeton, IL (US)

(72) Inventors: Alex Jon Cochran, Princeton, IL (US); Clifford Watrin, Princeton, IL (US); Alexandria VanAusdall, Princeton, IL (US)

(21) Appl. No.: 18/417,721

(22) Filed: Jan. 19, 2024

Related U.S. Application Data
(60) Provisional application No. 63/480,787, filed on Jan. 20, 2023.

(51) Int. Cl. A01N 63/22; A01N 25/02; A01N 25/14; A01P 3/00

(52) U.S. Cl. CPC A01N 63/22; A01N 25/02; A01N 25/14; A01P 3/00

(57) ABSTRACT

A stabilized biofungicide composition comprising: a biological fungicide comprising a rhizobacterium; and a pesticide, wherein the biological fungicide and the pesticide are in a weight ratio of from about 1:1 to about 1000:1 is disclosed, along with methods of using the same.

### CROSS REFERENCE TO RELATED APPLICATIONS

This application claims priority under 35 U.S.C. § 119 to provisional patent application U.S. Ser. No. 63/480,787 filed Jan. 20, 2023. The provisional patent application is herein incorporated by reference in their entirety, including without limitation, the specification, claims, and abstract, as well as any figures, tables, appendices, or drawings thereof.

### FIELD OF THE INVENTION

The present disclosure relates generally to a method of utilizing stabilized biofungicide composition combined with synthetic pesticides.

### BACKGROUND OF THE INVENTION

The background description provided herein gives context for the present disclosure. Work of the presently named inventors, as well as aspects of the description that may not otherwise qualify as prior art at the time of filing, are neither expressly nor impliedly admitted as prior art.

Thus, there exists a need in the art a novel system for delivery of biofungicide and synthetic pesticide compositions in a more efficient manner.

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the present disclosure to improve on or overcome the deficiencies in the art.

### BRIEF DESCRIPTION OF THE DRAWINGS

Several embodiments in which the present disclosure can be practiced are illustrated and described in detail, wherein like reference characters represent like components throughout the several views. The drawings are presented for exemplary purposes and may not be to scale unless otherwise indicated.

FIG. 1 shows disease control AUDPC (Area Under the Disease Progress Curve) of powdery mildew on squash in Florida using Companion alone or in combination with synthetic fungicides.

FIG. 2 shows disease control AUDPC (Area Under the Disease Progress Curve) of powdery mildew on squash in Washington using Companion alone or in combination with synthetic fungicides.

FIG. 3 shows protocol for disease control trial of bacterial spot of tomato in North Carolina using Companion alone or in combination with synthetic fungicides.

FIG. 4 shows disease control AUDPC (Area Under the Disease Progress Curve) of bacterial spot of tomato in North Carolina using Companion alone or in combination with synthetic.

FIG. 5 shows Protocol for disease control trial of Rhizoctonia root rot on sugarbeet in Michigan using Companion alone or in combination with synthetic fungicides.

FIG. 6 shows Recoverable White Sugar Yield from disease control trial of Rhizoctonia root rot on sugarbeet in Michigan using Companion alone or in combination with synthetic fungicides.

FIG. 7 shows disease control trial of Cercospora leaf spot on sugarbeet in Michigan using Companion alone or in combination with synthetic fungicides.

FIG. 8 shows disease control trial (% Disease Severity) of Grey Leaf Spot in Illinois using Companion alone or in combination with synthetic fungicides.

FIG. 9 shows Corn yield from disease control trial of Grey Leaf Spot in Illinois using Companion alone or in combination with synthetic fungicides.

FIG. 10 shows disease control trial of Tar Spot (% Disease Severity and Yield) in Illinois using Companion alone or in combination with synthetic fungicides.

FIG. 11 shows disease control of White Mold in Wisconsin using Companion alone or in combination with synthetic fungicides.

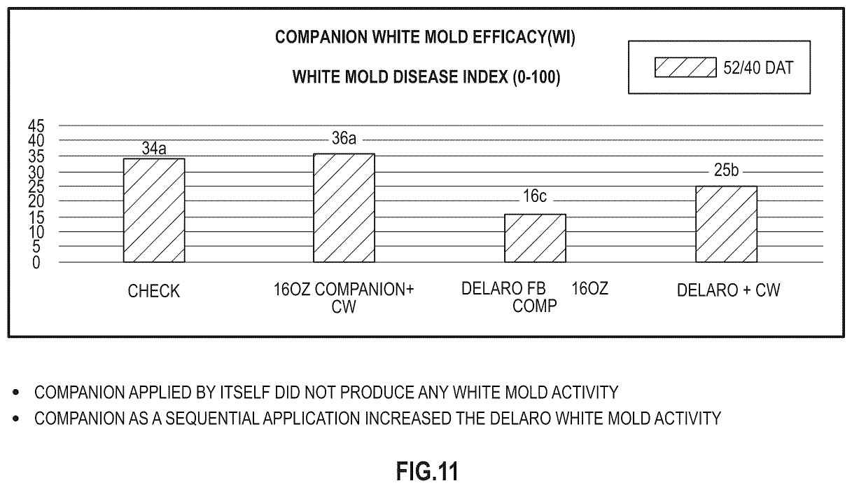

FIG. 12 shows enumeration data for Companion Maxx ST+Base Seed Treatment Slurry Material.

### DETAILED DESCRIPTION OF THE INVENTION

The present disclosure is not to be limited to that described herein. Mechanical, electrical, chemical, procedural, and/or other changes can be made without departing from the spirit and scope of the present disclosure. No features shown or described are essential to permit basic operation of the present disclosure unless otherwise indicated.

In one embodiment, the invention comprises a stabilized biofungicide composition comprising: a biological fungicide comprising a rhizobacterium; and a pesticide, wherein the biological fungicide and the pesticide are in a weight ratio of from about 1:1 to about 1000:1, along with methods of using the same.

In one embodiment, the combination of a biofungicide with synthetic pesticides adds convenience to the grower. In another embodiment, the combination of the biofungicide with the synthetic pesticide adds stabilization of the formulation.

### Glossary

Unless defined otherwise, all technical and scientific terms used above have the same meaning as commonly understood by one of ordinary skill in the art to which embodiments of the present disclosure pertain.

The terms “a,” “an,” and “the” include both singular and plural referents.

The term “or” is synonymous with “and/or” and means any one member or combination of members of a particular list.

The terms “disclosure”, “invention” or “present invention” are not intended to refer to any single embodiment of the particular disclosure but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “colony-forming unit” (CFU, cfu or Cfu) is a unit which estimates the number of microbial cells (bacteria, fungi, viruses etc.) in a sample that are viable, able to multiply via binary fission under the controlled conditions. Counting with colony-forming units requires culturing the microbes and counts only viable cells, in contrast with microscopic examination which counts all cells, living or dead. The visual appearance of a colony in a cell culture requires significant growth, and when counting colonies, it is uncertain if the colony arose from one cell or a group of cells. Expressing results as colony-forming units reflects this uncertainty.

The term “fertilizer” refers to a granular or aqueous solution or suspension containing soluble nitrogen. In some examples, the soluble nitrogen in a liquid fertilizer includes an organic source of nitrogen such as urea, or urea derived from anhydrous ammonia (such as a solution of urea and ammonium nitrate (UAN)). Aqua ammonia (20-32% anhydrous ammonia) can also be used. In other examples, the soluble nitrogen in a liquid fertilizer includes nitrogen-containing inorganic salts such as ammonium hydroxide, ammonium nitrate, ammonium sulfate, ammonium pyrophosphate, ammonium thiosulfate or combinations of two or more thereof. In some embodiments the liquid fertilizer includes a non-naturally occurring nitrogen source (such as ammonium pyrophosphate or ammonium thiosulfate) and/or other non-naturally occurring components. Common liquid non-natural fertilizer blends are specified by their content of nitrogen-phosphate-potassium (N-P-K percentages) and include addition of other components, such as sulfur or zinc. Examples of human-made blends include 10-34-0, 10-30-0 with 2% sulfur and 0.25% zinc (chelated), 11-37-0, 12-30-0 with 3% sulfur, 2-4-12, 2-6-12, 4-10-10, 3-18-6, 7-22-5, 8-25-3, 15-15-3, 17-17-0 with 2% sulfur, 18-18-0, 18-18-0 with 2% sulfur, 28-0-0 UAN, 9-27-0 with 2% sulfur and potassium thiosulfate.

As used herein, “microbe” refers to a microorganism, including but not limited to bacteria, archaebacteria, fungi, and algae (such as microalgae). In some examples, microbes are single-cellular organisms (for example, bacteria, cyanobacteria, some fungi, or some algae). In other examples, the term microbes includes multi-cellular organisms, such as certain fungi or algae (for example, multicellular filamentous fungi or multicellular algae).

As used herein, “microbial biopesticide” refers to a composition (which can be solid, liquid, or at least partially both) that includes at least one microbe (or a population of at least one microbe) and functions as a pesticide. In some examples, a microbial composition is one or more microbes (or one or more populations of microbes) in a liquid medium (such as a storage, culture, or fermentation medium), for example, as a suspension in the liquid medium. In other examples, a microbial composition is one or more microbes (or one or more populations of microbes) on the surface of or embedded in a solid or gelatinous medium (including but not limited to a culture plate), or a slurry or paste.

As used herein, “biofungicide” refers to a microbial biopesticide which is effective against fungal pathogens.

The term “microbial consortium” refers to a mixture, association, or assemblage of two or more microbial species, which in some instances are in physical contact with one another. The microbes in a consortium may affect one another by direct physical contact or through biochemical interactions, or both. For example, microbes in a consortium may exchange nutrients, metabolites, or gases with one another. Thus, in some examples, at least some of the microbes in a consortium may be metabolically interdependent. Such interdependent interactions may change in character and extent through time and with changing culture conditions.

To the extent to which any of the preceding definitions is inconsistent with definitions provided in any patent or non-patent reference incorporated herein by reference, any patent or non-patent reference cited herein, or in any patent or non-patent reference found elsewhere, it is understood that the preceding definition will be used herein.

There are few issues more threatening to crop health, and ultimately yield, than disease. Severe attacks on plants can inhibit a successful harvest and maximum yield potential. The instant invention provides a combined, shelf-stable mechanism to control these threats.

Bacillus amyloliquefaciens strain ENV503 is a plant growth promoting rhizobacterium that quickly establishes beneficial colonies on the plant's roots and leaves. This 100% water-dispersible, broad-spectrum biological fungicide is specially designed to prevent, control and suppress soil-borne and foliar disease, stimulate plant's natural defenses, enhance crop fertility, and promote increased plant growth and stress resistance. Bacillus amyloliquefaciens strain ENV503 triggers the plant's own immune system and disrupts pathogen cell walls from forming. This biofungicide contains microbes that break down cellulose and sugars to reduce stress, resulting in healthier soils and greater plant resistance.

Microbial biopesticides are typically added as a tank mix at the point of application to minimize microbial loss in mixture with synthetic pesticides, resulting in lack of availability for an all in one shelf-stable solution. In one embodiment, the invention deploys a bacterial biopesticide (Bacillus amyloliquafaciens strain ENV503) with synthetic pesticides. This unique bacillus strain also stimulates healthier roots and improves nutrient uptake, while protecting roots from invading pathogens.

Bacillus amyloliquefaciens strain ENV503 produces broad-spectrum antibiotic lipopeptides (iturin) that disrupt pathogen cell-wall formation and is a competitive, fast-colonizing rhizosphere bacterium that occupies the plant's root hairs and leaves. It also prevents the growth and antagonistic effects of soilborne and foliar pathogens. Bacillus amyloliquefaciens strain ENV503 is also known to stimulate phytohormones that trigger the plant's systemic resistance to disease (Induced Systemic Resistance—ISR), the defense mechanisms of the plant, for prolonged periods of time. Current products comprising ENV503 are referenced under the brand “Companion” and include Companion® Maxx ST (as a seed treatment) and Companion® Maxx WP (as a wettable powder); EPA Registration Number 94485-5, said label incorporated herein by reference in their entirety. However, no products are currently in the market which comprise ENV503 in combination with other pesticides.

A list of diseases for which ENV503 is effective is shown below in Table 1.

TABLE 1
Disease List

| Pathogen | Disease |
|---|---|
| Alternaria alternate | Brown Spot, Leaf Spot, Stem-End Rot |
| Alternaria spp. | Black Root Rot, Early Blight |
| Aspergillus spp. | Crown Rot, Damping-off Fungus, Gray |
| Botrytis cinerea | Mold, Leaf Blight |
| Candidatus Liberibacter spp. | Greening (Huanglongbing (HLB)) |
| Colletotrichum acutatum | Post-Bloom Fruit Drop |
| Colletotrichum orbiculare, | Anthracnose |
| Colletotrichum spp. | |
| Didymella bryoniae | Gummy Stem Blight |
| Erwinia spp. | Soft Rot, Angular Leaf Spot, |
| | Bacterial Soft Rot |
| Erwinia carotovora | Cucurbit Wilting, Angular Leaf |
| | Spot, Bacterial Soft Rot |
| Erwinia tracheiphila | Cucurbit Wilting, Angular Leaf |
| | Spot, Bacterial Soft Rot |
| Fusarium nivale | Fusarium Patch |
| Fusarium oxysporum | Wilt |
| Fusarium solani | Areolate Leaf Spot |
| Fusarium spp. | Root Rot, Wilt |
| Golovinomyces cichoracearum | Powdery Mildew |
| (formerly called Erysiphe | |
| cichoracearum) | |
| Magnaporthe poae | Summer Patch |
| Mycosphaerella spp. | Black Sigatoka |
| Mycosphaerella citri | Greasy Spot |
| Phytophthora aerial blight | Blight, Leaf Spot and Rot |
| Phytophthora spp. | Late Blight, Blackeye/Buckeye Rot in |
| | Tomatoes - |
| | Brown Rot, Food Rot |
| | Crown and Root Rot |
| Plasmodiophora brassicae | Corky Root, Clubroot |
| Podosphaera xanthii | Powdery Mildew |
| (formerly called Sphaerotheca | |
| fuliginea) | |
| Pseudomonas syringae | Angular Leaf Spot |
| Pythium aphanidermatum | Root Rot |
| Pythium irregulare | Root Rot |
| Pythium spp. | Root Rot, Damping-off, Pythium |
| Rhizoctonia spp. | Brown Patch |
| Rhizoctonia solani | Root Rot, Bottom/Stem Rot |
| Sclerospora graminicola | Downy Mildew |
| Sclerotinia | Dollar Spot |
| Sclerotinia minor | Blight |
| | Lettuce Drop |
| Septoria lycopersici | Septoria Leaf Spot |
| Uncinula necator | Powdery Mildew |
| Xanthomonas campestris | Bacterial Blight/Leaf Spot |
| Xanthomonas axonopodis | Citrus Canker |

In one embodiment, crops to which the invention can be applied include berries, including but not limited to: Blackberry (includes Bingleberry, Black Satin Berry, Boysenberry, Cherokee Blackberry, Chesterberry, Cheyenne Blackberry, Coryberry, Darrowberry, Dewberry, Dirksen Thornless Berry, Himalayaberry, Hullberry, Lavacaberry, Loganberry, Lowberry, Lucretiaberry, Mammoth Blackberry, Marionberry, Nectarberry, Olallieberry, Oregon Evergreen Berry, Phenomenalberry, Rangeberry, Ravenberry, Rossberry, Shawnee Blackberry and Youngberry), Blueberry, Cranberry, Currant, Elderberry, Strawberry, Gooseberry, Huckleberry, Raspberry (Black and Red) and Cultivars, Varieties and/or Hybrids of These.

In another embodiment, crops to which the invention can be applied include but are not limited to: brassica (Cole) Leafy Vegetables, including: Broccoli, Chinese Broccoli, Broccoli Raab, Brussels Sprouts, Cabbage, Chinese Cabbage (Bok Choy and Napa), Chinese Mustard Cabbage (Gai Choy), Cauliflower, Cavalo Broccolo, Collards, Kale, Kohlrabi, Mizuna, Mustard Greens, Mustard Spinach and Rape Greens.

In yet a further embodiment, crops to which the invention can be applied include Cucurbit Vegetables, including but not limited to: Chayote, Chinese Waxgourd, Citron Melon, Cucumber, Gherkin, Edible Gourds (includes Chinese Okra, Cucuzza, Hechima and Hyotan), Momordica spp. (includes Balsam Apple, Balsam Pear, Bitter Melon and Chinese Cucumber), Muskmelon (includes True Cantaloupe, Cantaloupe, Casaba, Crenshaw Melon, Golden Pershaw Melon, Honeydew Melon, Honey Balls, Mango Melon, Persian Melon, Pineapple Melon, Santa Claus Melon, Snake Melon and Hybrids and/or Cultivars of Cucumis melon), Pumpkin, Summer Squash (includes Crookneck Squash, Scallop Squash, Straightneck Squash, Vegetable Marrow and Zucchini), Winter Squash (includes Acorn Squash, Butternut Squash, Calabaza, Hubbard Squash and Spaghetti Squash) and Watermelon (includes Cultivars, Hybrids and/or Varieties of Citrullus lanatus).

In another embodiment, crops to which the invention can be applied include Citrus Fruits, including but not limited to: Citron, Citrus Hybrids, Grapefruit, Kumquat, Lemon, Lime, Mandarin, Orange, Pummelo, Satsuma Mandarin, Tangelo, Tangerine and Cultivars, Varieties and/or Hybrids of These.

In an additional embodiment, crops to which the invention can be applied include Vine Crops including but not limited to: Grape (Wine, Table and Raisin), Kiwifruit and Passionfruit.

In another embodiment, crops to which the invention can be applied comprise Herbs and Spices, including: Allspice, Angelica, Anise, Annatto, Basil, Chamomile, Caraway, Cardamom, Cassia, Celery Seed, Chervil (Dried), Chives, Cinnamon, Coriander, Cumin, Curry, Dill, Fennel, Fenugreek, Horehound, Hyssop, Juniper Berry, Lavender, Lemongrass, Lovage, Mace, Marigold, Marjoram, Mint, Mustard, Nasturtium, Nutmeg, Oregano, Parsley (Dried), Pepper, Rosemary, Rue, Saffron, Sage, Savory, Sweet Bay, Tansy, Tarragon, Thyme, Vanilla, Wintergreen, Woodruff and Wormwood; Fruiting Vegetables, including Eggplant, Groundcherry, Okra, Pepino, Pepper (includes Bell Pepper, Chili Pepper, Cooking Pepper, Pimento and Sweet Pepper), Tomatillo, Tomato and Cultivars, Varieties and/or Hybrids of These; other leafy vegetables including Amaranth, Arugula, Cardoon, Celery, Celtuce, Chervil, Chinese Celery, Chrysanthemum (Edible-Leaved and Garland), Corn Salad, Cress (Garden and Upland), Dandelion, Dock (Sorrel), Endive (Escarole), Fennel, Lettuce (Head and Leaf), Orach, Parsley, Purslane (Garden and Winter), Radicchio, Rhubarb, Spinach, Spinach (New Zealand and Vine) and Swiss Chard, including Those Grown for Seed Production; Legume Vegetables, including Bean, Broad Bean, Chickpea, Guar, Jackbean, Lentil, Pea, Pigeon Pea and Soybean; Bulb Vegetables, including Fresh Leaves Chive, Garlic, Leck, Onion, Shallot and Cultivars, Varieties and/or Hybrids of These; Root and Tuber Vegetables, including Arracacha, Arrowroot, Artichoke, Beet, Carrot, Cassava, Celeriac, Chayote (Root), Chervil (Turnip-Rooted), Chicory, Chufa, Dasheen, Ginger, Ginseng, Horseradish, Parsnip, Potato, Radish, Rutabaga, Salsify, Skirret, Sweet Potato, Turmeric, Turnip and Yam; and Tropical and Subtropical Fruits, Banana, Coffee, Plantain, Mango, Papaya, Avocado and Pineapples.

In another embodiment, crops to which the invention can be applied comprise Grasses Grown for Seed, Sod Production and Pasture and Forage Grasses.

Bacillus amyloliquefaciens strain ENV503 is within the plant growth-promoting rhizobacteria (PGPR) classification. PGPR are free-living bacteria that have beneficial effects on plants as they increase plant productivity and enhance crop fertility, growth and root development.

This mixture of ENV503 and synthetic pesticides could be applied in multiple methods including but not limited to in-furrow at seeding, sidedressed after planting, injected in irrigation systems, or as a foliar broadcast treatment. This invention combines Bacillus Amyloliquifaciens strain ENV503 with synthetic pesticides at a ratios from 1:1 to 1000:1. This blend remains stable for multiple months.

ENV503 bacteria that colonizes the developing root systems of plants, suppressing disease organisms including but not limited to Fusarium, Rhizoctonia, and Aspergillus that attack those root systems. As the root system develops, the bacteria grow with the roots, extending the protection throughout the growing season. As a result of this protection, a vigorous root system is established by the plant, which often results in more uniform stands and greater yields.

In addition, ENV503 has been shown to increase the amount of nodulation by nitrogen-fixing bacteria when used on many legumes. This improvement in nodulation is a result of a healthier root system that allows more sites for nodules to form from soilborne, nitrogen-fixing bacteria.

In one embodiment, the instant invention provides a convenient all in one stabilized solution that does not require mixing at the point of use risking mis-application due to improperly measured individual components. In a further embodiment, the invention ensures the dosing of microorganisms is properly applied. In one embodiment, the invention enhances pesticide performance. In another embodiment, the pesticide is a fungicide and/or a bacteriocides. In yet an additional embodiment, the biofungicide could be combined together with an insecticide and a nematicide or a herbicide. In another embodiment, the biofungicide-pesticide combination could be applied as a seed treatment.

Those of ordinary skill in the art would understand how to apply embodiments of the instant invention through aerial spray, foliar, foliar broadcast, in-furrow treatment, sidedressing, soil drench, or injection through an irrigation system.

An artisan of ordinary skill need not view, within isolated figure(s), the near infinite number of distinct permutations of features described in the following detailed description to facilitate an understanding of the present disclosure.

### Embodiments

Various embodiments of the systems and methods provided herein are included in the following non-limiting list of embodiments. These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

1. A stabilized biofungicide composition comprising:
a biological fungicide comprising a rhizobacterium; and
a pesticide, wherein the biological fungicide and the pesticide are in a weight ratio of from about 1:1 to about 1000:1.

2. The biofungicide composition of embodiment 1, wherein the rhizobacterium comprises Bacillus Amyloliquifaciens, Bacillus Lichenformis, Bacillus Megaterium, Bacillus Pumilis, and combinations thereof.

3. The biofungicide composition of any one of embodiment 1 to 2, wherein the rhizobacterium comprises Bacillus Amyloliquifaciens strain ENV503.

4. The biofungicide composition of any one of embodiments 1 to 3, wherein the pesticide comprises a synthetic pesticide.

5. The biofungicide composition of any one of embodiments 1 to 4, wherein the pesticide comprises a fungicide, an insecticide, a nematicide, a herbicide, a bactericide, or combinations thereof.

6. The biofungicide composition of any one of embodiments 1 to 5, wherein the pesticide comprises a fungicide and/or a bactericide.

7. The biofungicide composition of any one of embodiments 1 to 5, wherein the pesticide comprises an insecticide, a nematicide, and/or a herbicide.

8. The biofungicide composition of any one of embodiments 1 to 7, wherein the composition further comprises a fertilizer, a micronutrient, an organic material, a wetting agent, an adjuvant, a surfactant, or combinations thereof.

9. The biofungicide composition of any one of embodiments 1 to 8, wherein the composition is an aqueous composition.

10. The biofungicide composition of any one of embodiments 1 to 8, wherein the composition is a wettable powder.

11. The biofungicide composition of any one of embodiments 1 to 10, wherein the biofungicide composition is shelf stable for at least about 1 month, at least about 2 months, or at least about 3 months.

12. A method of increasing crop yield comprising:
applying to a crop the biofungicide composition of any one of embodiments 1 to 11

13. A method of reducing the amount of synthetic pesticides used in crop production comprising:
applying to a crop the biofungicide composition of any one of embodiments 1 to 11.

14. A method of prevention, control, and/or suppression of soil and/or foliar diseases comprising:
applying to a crop the biofungicide composition of any one of embodiments 1 to 11.

15. A method of enhancing synthetic pesticide performance comprising:
applying to a crop the biofungicide composition of any one of embodiments 1 to 11.

16. A method of increasing crop yield comprising:
combining a biological fungicide comprising a rhizobacterium and a synthetic pesticide to obtain a biofungicide composition, wherein the biological fungicide and the synthetic pesticide are in a weight ratio of from about 1:1 to about 1000:1; and applying the biofungicide composition to a crop.

17. The method of any one of embodiments 12 to 16, wherein the biofungicide composition is applied sidedressed, in-furrow at seeding, sidedressed after planting, injected in irrigation systems, or as a foliar broadcast treatment.

18. The method of any one of embodiments 12 to 17, wherein the biofungicide composition is applied in-furrow.

19. The method of embodiments 18, wherein the biofungicide composition is applied via soil drench.

20. The method of any one of embodiments 12 to 17, wherein the biofungicide composition is injected in an irrigation system and applied during an irrigation.

21. The method of any one of embodiments 12 to 17, wherein the biofungicide composition is applied foliar.

22. The method of embodiments 21, wherein the biofungicide composition is applied as a foliar broadcast treatment.

23. The method of any one of embodiments 12 to 22, wherein the application comprises from about 0.1 gal/A to about 500 gal/A, or from about 0.1 gal/A to about 10 gal/A of the biofungicide composition.

24. The method of any one of embodiments 12 to 23, wherein the crop comprises corn, soybeans, forages, potatoes, tomatoes, trees, vines, citrus, nuts, sugar beets, fruits, vegetables, and/or woody crops.

25. The method of any one of embodiments 12 to 24, wherein the crop yield is increased by at least about 5% or by at least about 15%.

26. The method of any one of embodiments 12 to 25, wherein the method reduces the amount of synthetic pesticide used in crop production by at least about 10% by weight, by at least about 25% by weight, or at least about 50% by weight.

### EXAMPLES

Biological Fungicide Performance in Combination with Commercial Fungicide Standards

### Objective:

Evaluate performance of the biofungicide in combination with commercial fungicide standards for disease control.

### Methods and Materials:

Biological Fungicide was tested in trials in several states on several foliar diseases in vegetables, sugar beets and corn to evaluate efficacy when used in combination with commercial fungicides.

### Experimental Design:

In vegetable and sugar beets, replicated trials were established with university and contract researchers; corn trials were established on-farm in large replicated strip plots.

### Results:

Across several trials in crops tested, Companion plus commercial fungicide reduced disease significantly from the untreated control. In corn, additional effect on senescence delay was observed.

### Conclusions:

Performance of a biological fungicide when combined with commercial fungicide has promising implications for enhanced disease control, fungicide resistance management and senescence—which may indicate improved stalk health and the potential for reduced greensnap (stalk lodging that drastically reduces yields) prior to corn harvest.

### Example 1: Companion Squash Powdery Mildew Evaluation—2021 U FL IFAS Research Center, Imokalee FL

Crop: Squash (Cucurbita pepo)

Disease Target: Powdery mildew (Podosphaera xanthii)

Timing: Fall 2021.

The experiment was conducted at the UF/IFAS Southwest Florida Research and Education Center located in Immokalee, FL (26.460852, −81.435593). The soil is an Immokalee fine sand (Sandy, siliceous, hyperthermic Arenic Alaquods). Field preparation, fertility, irrigation, and pest management were conducted based upon UF/IFAS guidelines established in the Vegetable Production Handbook of Florida.

Raised beds were prepared to be 32 inches wide at the top, spaced on 6 ft centers, and covered with white on black TIF polyethylene mulch (Berry Global Inc, Sarasota, FL, USA). On 13 Sep. 2021 open pollinated ‘Yellow Crookneck’ (Johnny's Selected Seeds, Winslow, ME, USA) squash seedlings were transplanted. Each plot consisted of 8 plants spaced 12 inches apart within 8 ft of row with a 10 ft buffer between plots.

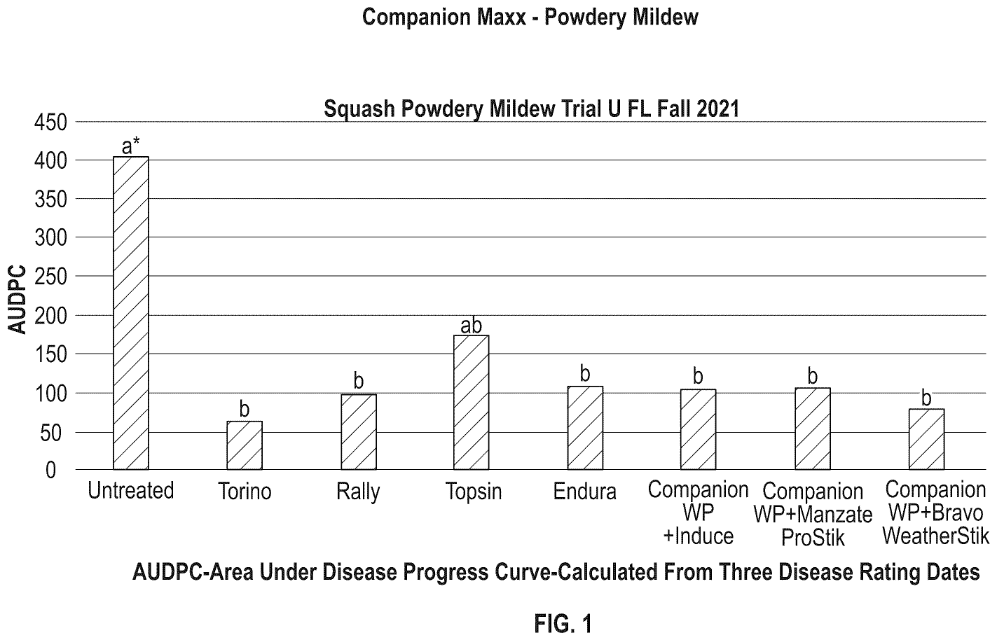

All treatment applications were conducted using a high clearance sprayer at 2.18 mph and 40 psi. A double drop boom equipped with a total of 8 nozzles sprayed 90 gal/A application volume. Powdery mildew was confirmed on plants in control plots on Oct 11 at very low (<1%) severity. Since powdery mildew occurs primarily on the underside of leaves, five individual leaves were removed at random from the plants on the inside of the plot (not the two buffer plants at either end of plot) and flipped over for disease severity rating. Plant leaves were selected at random however leaves of approximately the same age and position in the canopy were chosen from the interior plants for rating. Area under the disease progress curve (AUDPC) was calculated from the three rating dates (see FIG. 1).

### Example 2. Companion Squash Powdery Mildew Evaluation—2022 Agriculture Development Group—Pasco WA

The research staff at Agriculure Development Group, Inc. conducted a field trial at 15 miles north of Pasco, WA, investigating the impact of Companion biofungicide treatments on powdery mildew control and production in squash. Squash was seed in the greenhouse on 6/1 and then transplanted into the field on 6/28. The experimental design for this trial was an RCB with 4 replications and plot sizes of 12 ft (2 beds plus a driveway)×30 feet. Six applications were made on 8/24 (A), 8/31 (B), 9/7 (C). 9/14 (D), 9/21 (E) with a tractor mounted multi-boom sprayer that sprays 50 GPA.

Powdery mildew incidence (% infected plants) and severity (% infected area over infected canopy) on whole plot basis were assess on 9/7, 9/14, 9/21, and 9.27. Leaf samples were taken on 8/30 and overall crop vigor was also evaluated on 9/21.

To better assess cumulative infection incidence and severity condition in the field following time change, area under disease progress curve (AUDPC) was also calculated for both incidence and severity using the equation:

$${\sum }_{i = 1}^{{N}_{i} - 1} \frac{( {y}_{i} + {y}_{i + 1} )}{2} ( {t}_{i + 1} - {t}_{i} )$$

Where yᵢ is the % incidence or severity at day tᵢ, yᵢ₊₁ is the % incidence or severity at day tᵢ₊₁. In our case, tᵢ₊₁−tᵢ=7 days interval between each rating dates.

Generally, all treatments reduced the infection incidence and severity compared to untreated check. Among these treatments, Bravo alone (treatment 2) or in combination with Companion BF (treatment 7) repeated for all 5 applications achieved the lowest infection incidence and severity consistently across all rating dates. For instance, while untreated check already reached 78.8% incidence and 30% severity on 9/7, these two treatments maintained only 8.8 and 7.5% incidence as well as only 6.3 and 5% severity. Untreated check ended in 100% infection incidence and 97.5% severity by the last rating (9/27) where treatments 2 and 7 kept around 45% incidence and 25% severity.

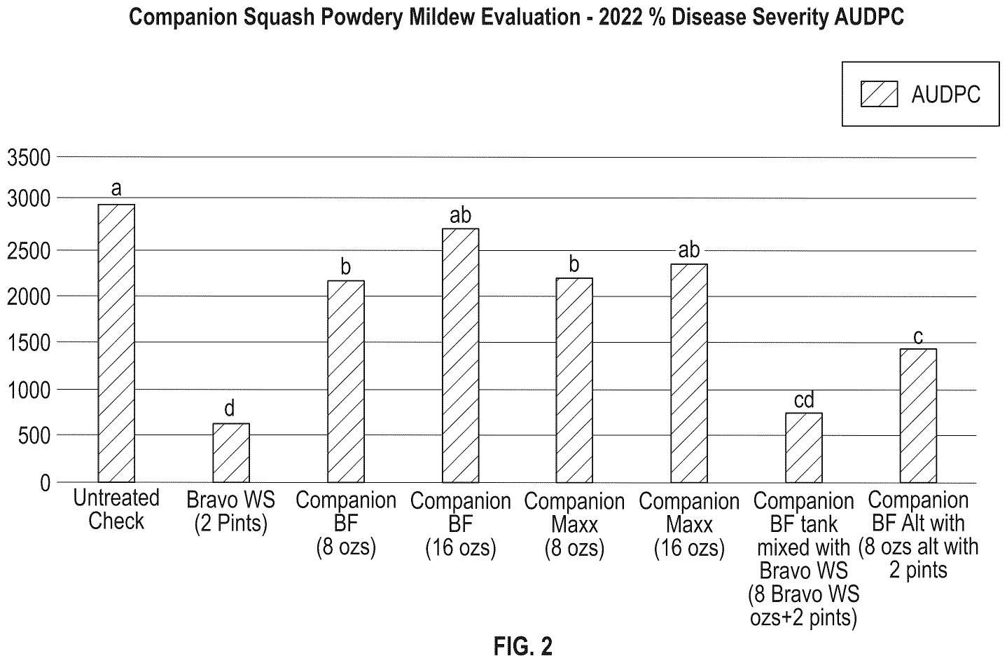

Conclusion: Under extreme disease pressure, Companion BF and Companion Maxx provided equivalent disease control that was significantly weaker than the standard. Companion tank mixed with the commercial standard and alternation programs were statistically equal (see FIG. 2).

### Example 3: Companion Maxx—Tomato Diseases

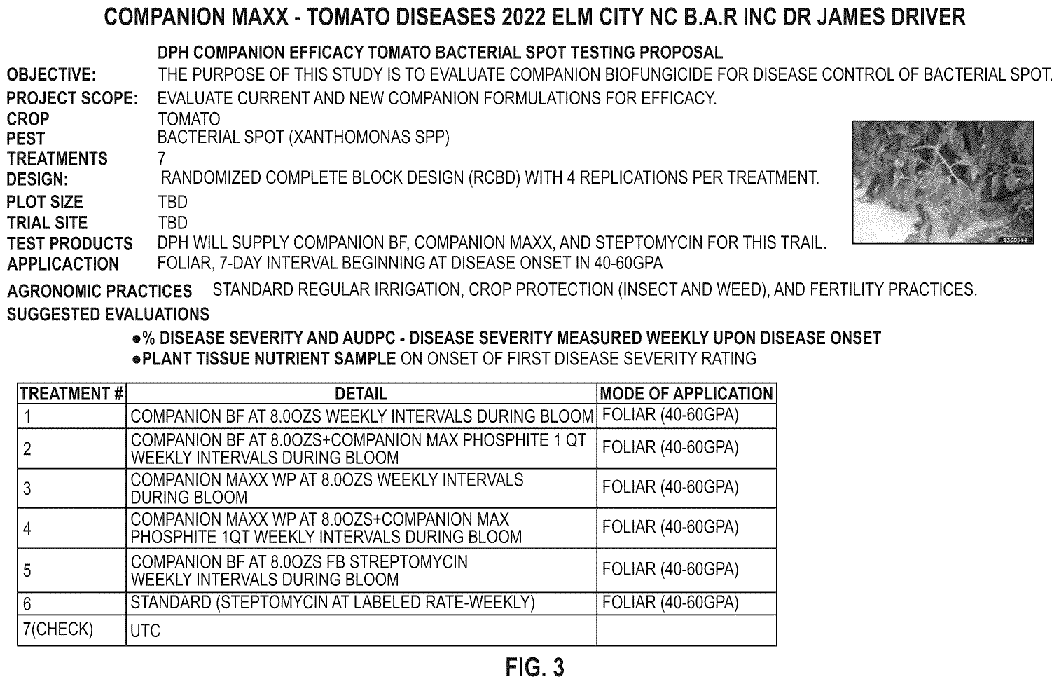

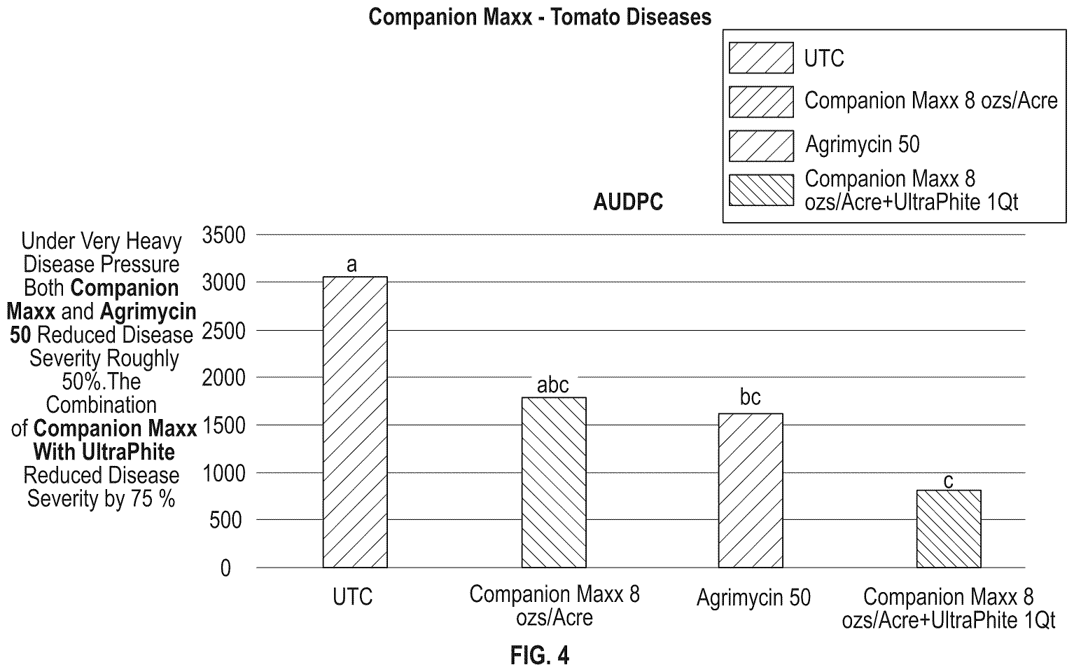

Under very heavy disease pressure both Companion Maxx and Agrimycin 50 reduced disease severity roughly 50%. The combination of Companion Maxx with UltraPhite reduced disease severity by 75%. (see FIGS. 3 and 4).

### Example 4: Sugarbeet Diseases

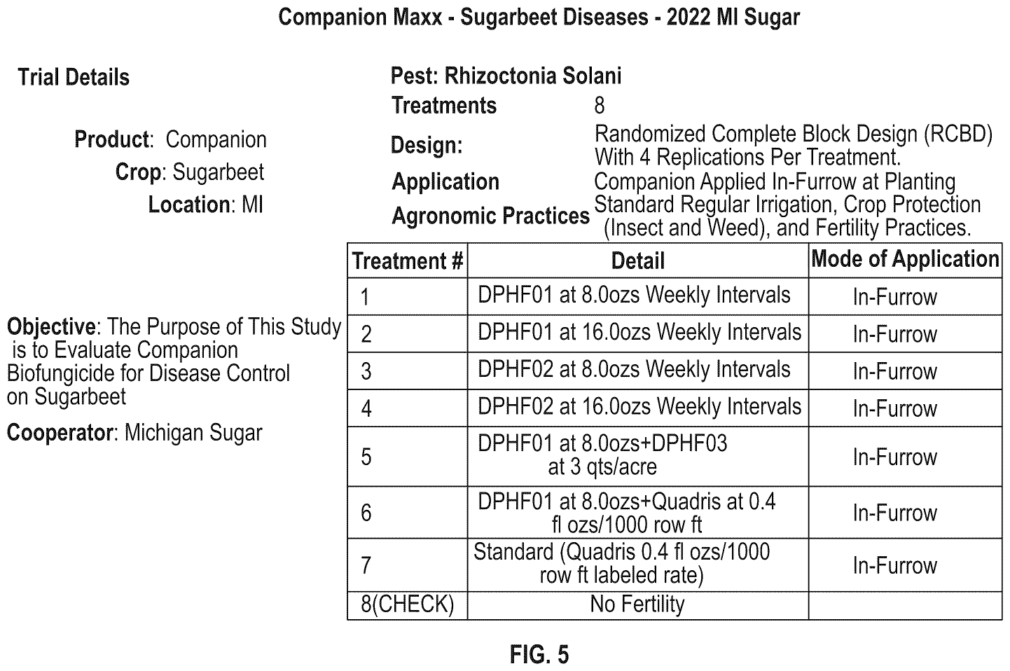

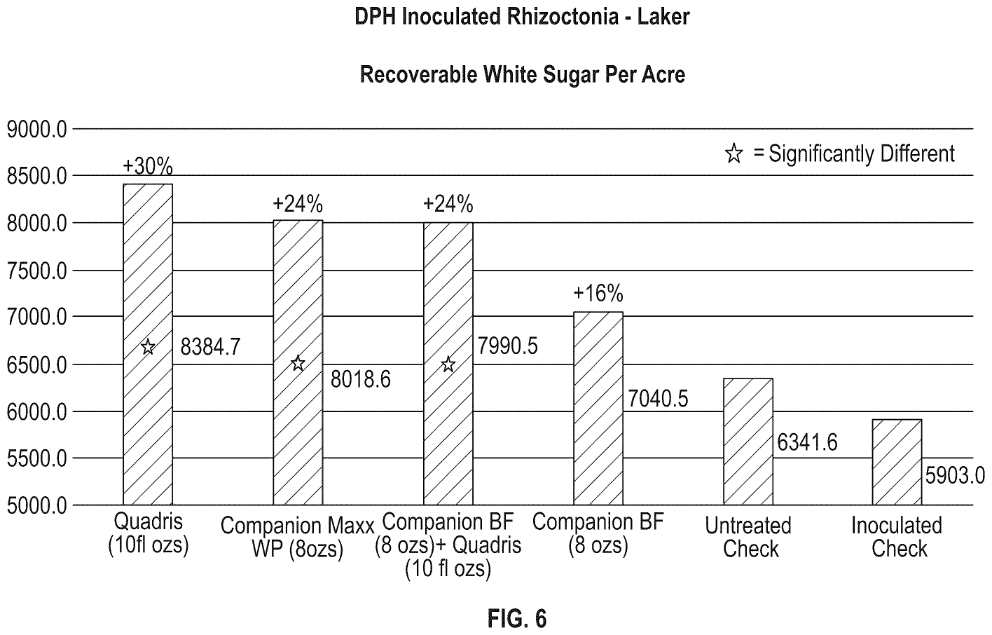

The Purpose of This Study was to Evaluate Companion Biofungicide for Disease Control on Sugarbeet. This trial was a randomized complete block design with four replications per treatment. Biofungicide was applied alone and in combination with another pesticide in-furrow per the specifications in FIG. 5. FIG. 6 illustrates the results, including the performance of the biofungicide alone and in combination with another pesticide. Recoverable sugar was significantly higher than the untreated check when formulations included Companion Maxx WP or Companion BF in combination with Quadris (see FIG. 6).

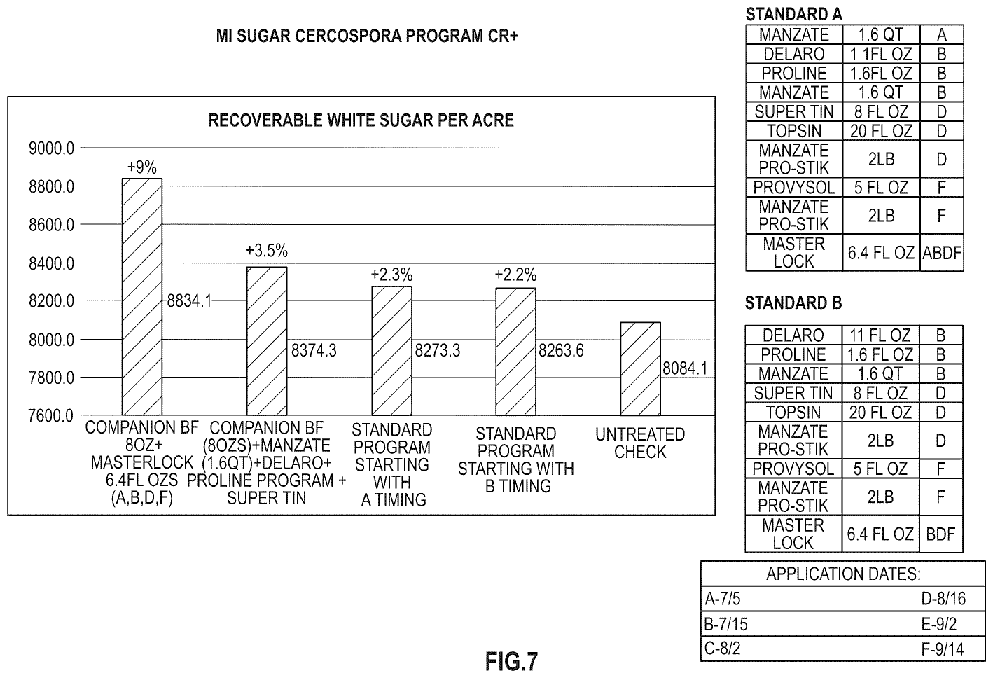

FIG. 7 illustrates another trial with standard program performance compared to biofungicide in combination with other pesticide(s). Recoverable sugar yield was higher for the treatments which included the biofungicide.

### Example 5: Trial Details—TRIAL #COM002-IL-DT-22

Product: Companion and Ultraphite

Crop: Corn

Location: Edgewood IL

Objective: Disease Evaluation in Corn

Fungicide applications made at R1 growth stage

Cooperator: JCB Ag Research

Treatments are as outlined in Table 2.

TABLE 2
Trial Details for TRIAL # COM002-IL-DT-22

| Treatment | Product | Amount | Unit |
|---|---|---|---|
| 1 | Untreated Check | N/A | N/A |
| 2 | Companion WP | 16 | oz wt/a |
| | NIS | 0.125 | % v/v |
| 3 | Ultraphite | 2 | qt/a |
| | NIS | 0.125 | % v/v |
| 4 | Ultraphite | 2 | qt/a |
| | Companion WP | 16 | oz wt/a |
| | NIS | 0.125 | % v/v |
| 5 | Miravis Neo | 13.7 | fl oz/a |
| | NIS | 0.125 | % v/v |
| 6 | Companion WP | 16 | oz wt/a |
| | Miravis Neo | 13.7 | fl oz/a |
| | NIS | 0.125 | % v/v |

### RESULTS: Companion/Ultraphite Disease Evaluation-Corn—TRIAL #COM-002-IL-22-DT

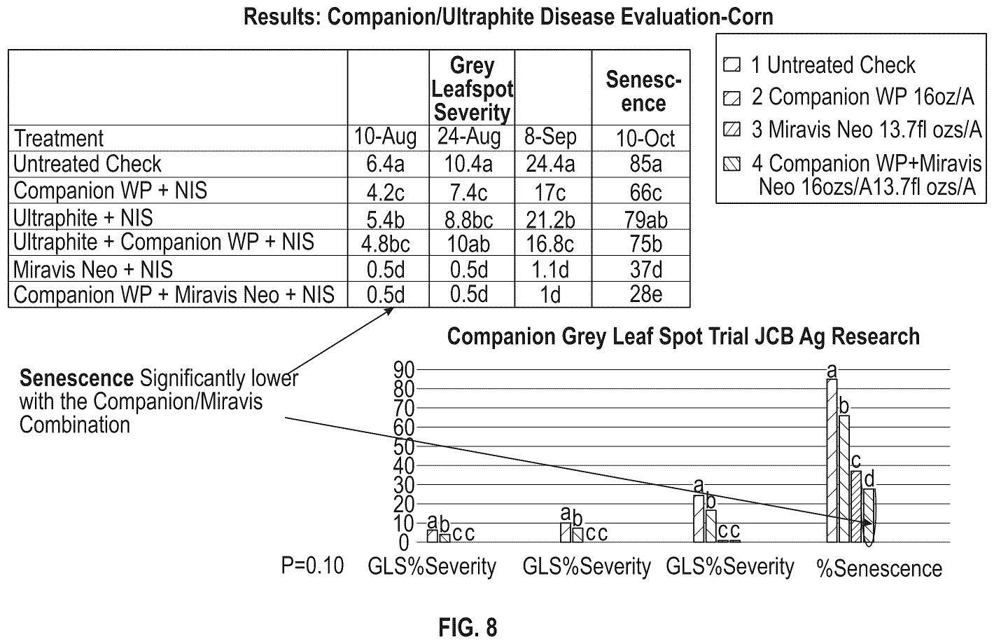

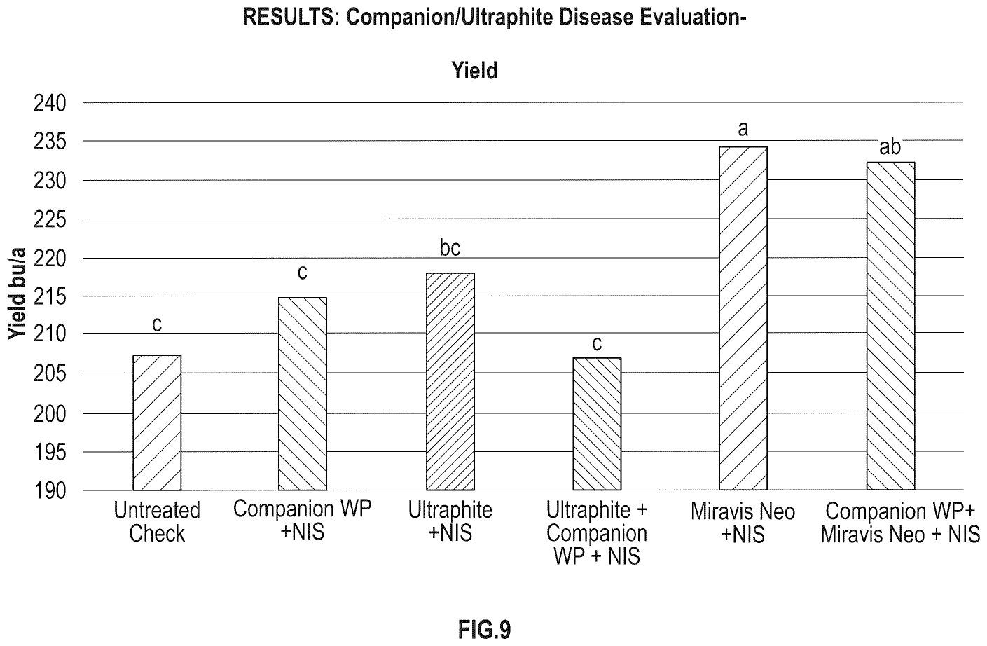

Results are shown in FIG. 8 showing grey leaf spot severity and change in senescence. Senescence was significantly lower with the Companion/Miravis combination (see FIG. 9).

Further results are shown in FIG. 9, where differences in yield are shown. In both figures, LSD: a=. 10 and letters followed by different letter are significantly different.

### Example 6. Companion Tar Spot Trial Corn Belt

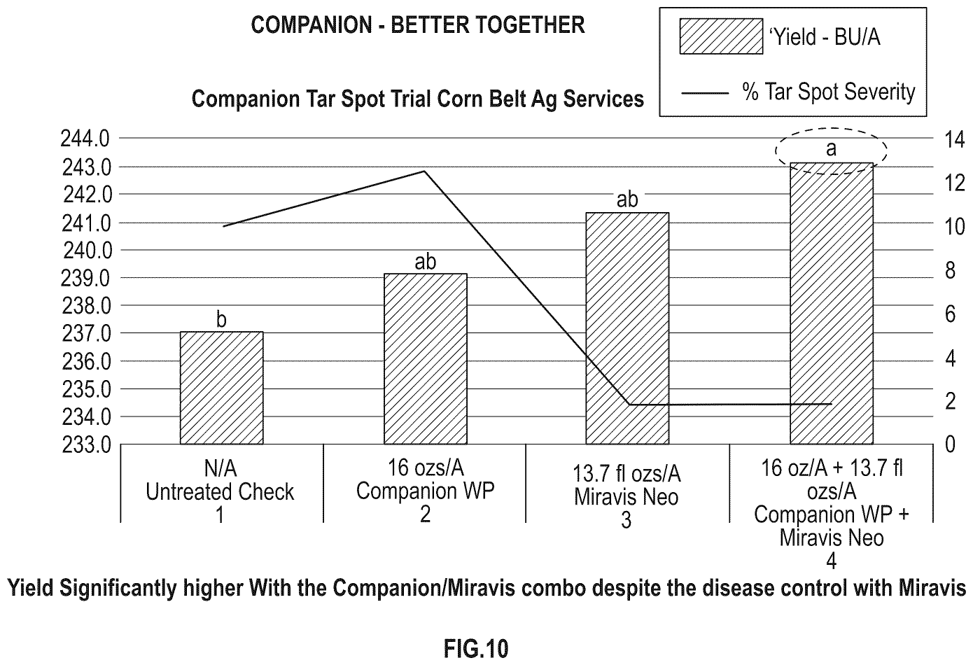

Treatments are as indicated in FIG. 10. Both tar spot severity and yield were measured as indicated. Corn yield was significantly higher with the Companion/Miravis combination (see FIG. 10). In both figures, LSD: a=. 10 and letters followed by different letter are significantly different.

### Example 7. Companion White Mold Efficacy

This study was located in Hancock, WI. There were two fungicide applications. Most treatments were one application which were represented by the 52 DAT (days after treatment). If the treatment had two applications, the second application were represented by the 40 DAT. CW is an abbreviation for Cide Winder which is an adjuvant and the rate used in the studies was 0.375% v/v. The white mold disease index is a calculation that includes the % disease incidence and the disease severity (scale of 0-3) ratings. The calculation multiplies the incidence by severity ratings and divides by 3; the resulting number is the disease index. This is a standard calculation for soybean white mold disease evaluations at the universities and in the industry. LSD: a=. 10 and letters followed by different letter are significantly different.

Companion applied by itself did not produce any white mold activity. Companion as a sequential application increased the Delaro white mold activity. The sequential application of Delaro fungicide with Companion is statistically better than Delaro alone applied twice.

### Example 8. Companion Maxx ST+Base Seed Treatment Slurry Material—Enumeration Data

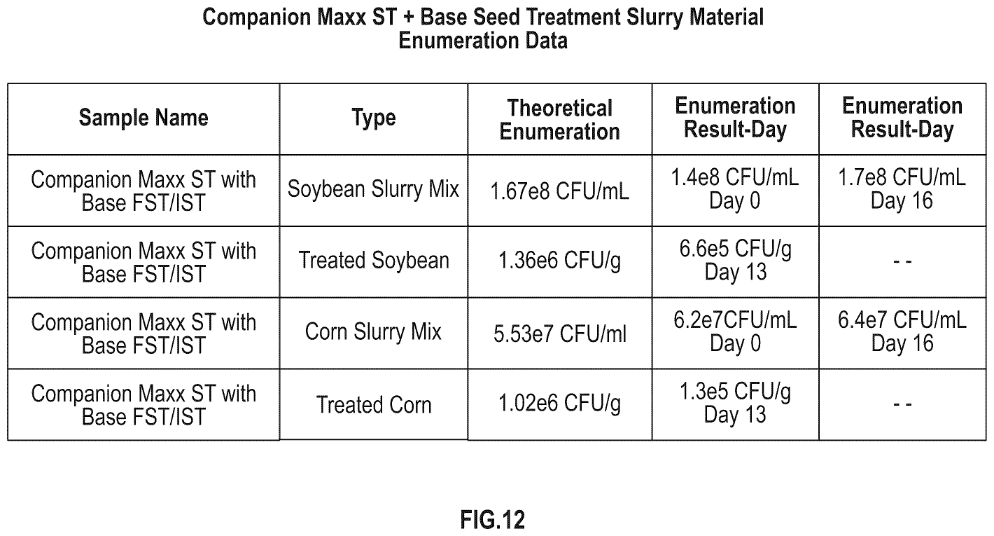

Base FST is a mixture of multiple synthetic fungicides. The IST is an insecticide. Base FST/IST means there was a base treatment of fungicide and insecticide seed treatments. Theoretical enumerations and enumeration results from Day 0 to Day 16 are as indicated in FIG. 12 for a soybean slurry mix, treated soybean, corn slurry mix, and treated corn. FIG. 12 demonstrates the stability of Bacillus amyloliquefaciens ENV503 when combined with a seed treatment slurry mixture including multiple fungicides, and insecticide, and a polymer coating. CFU's are the bacterial cells of ENV503 that act as a biological fungicide. The theoretical count is determined by math based on the number of CFU's added to the slurry mixture. This study demonstrates that the CFUs are stable after 16 days of being mixed with the slurry.

From the foregoing, it can be seen that the present disclosure accomplishes at least all of the stated objectives.

The following table of reference characters and descriptors are not exhaustive, nor limiting, and include reasonable equivalents. If possible, elements identified by a reference character below and/or those elements which are near ubiquitous within the art can replace or supplement any element identified by another reference character.

What is claimed is:

1. A stabilized biofungicide composition comprising:
a biological fungicide comprising a rhizobacterium; and
a pesticide,
wherein the biological fungicide and the pesticide are in a weight ratio of from about 1:1 to about 1000:1.

2. The biofungicide composition of claim 1, wherein the rhizobacterium comprises Bacillus Amyloliquifaciens, Bacillus Lichenformis, Bacillus Megaterium, Bacillus Pumilis, and combinations thereof.

3. The biofungicide composition of claim 1, wherein the rhizobacterium comprises Bacillus Amyloliquifaciens strain ENV503.

4. The biofungicide composition of claim 1, wherein the pesticide comprises a synthetic pesticide.

5. The biofungicide composition of claim 1, wherein the pesticide comprises a fungicide, an insecticide, a nematicide, a herbicide, a bactericide, or combinations thereof.

6. The biofungicide composition of claim 1, wherein the pesticide comprises a fungicide and/or a bactericide.

7. The biofungicide composition of claim 1, wherein the pesticide comprises an insecticide, a nematicide, and/or a herbicide.

8. The biofungicide composition of claim 1, wherein the composition further comprises a fertilizer, a micronutrient, an organic material, a wetting agent, an adjuvant, a surfactant, or combinations thereof.

9. The biofungicide composition of claim 1, wherein the composition is an aqueous composition.

10. The biofungicide composition of claim 1, wherein the composition is a wettable powder.

11. The biofungicide composition of claim 1, wherein the biofungicide composition is shelf stable for at least about 1 month, at least about 2 months, or at least about 3 months.

12. A method of increasing crop yield comprising:
applying to a crop the biofungicide composition of claim 1.

13. A method of reducing the amount of synthetic pesticides used in crop production comprising:
applying to a crop the biofungicide composition of claim 1.

14. A method of prevention, control, and/or suppression of soil and/or foliar diseases comprising:
applying to a crop the biofungicide composition of claim 1.

15. A method of enhancing synthetic pesticide performance comprising:
applying to a crop the biofungicide composition of claim 1.

16. A method of increasing crop yield comprising:
combining a biological fungicide comprising a rhizobacterium and a synthetic pesticide to obtain a biofungicide composition, wherein the biological fungicide and the synthetic pesticide are in a weight ratio of from about 1:1 to about 1000:1; and
applying the biofungicide composition to a crop.

17. The method of any one of claims 12 to 16, wherein the biofungicide composition is applied sidedressed, in-furrow at seeding, sidedressed after planting, injected in irrigation systems, or as a foliar broadcast treatment.

18. The method of any one of claims 12 to 16, wherein the biofungicide composition is applied in-furrow.

19. The method of claim 18, wherein the biofungicide composition is applied via soil drench.

20. The method of any one of claims 12 to 16, wherein the biofungicide composition is injected in an irrigation system and applied during an irrigation.

21. The method of any one of claims 12 to 16, wherein the biofungicide composition is applied foliar.

22. The method of claim 21, wherein the biofungicide composition is applied as a foliar broadcast treatment.

23. The method of any one of claims 12 to 16, wherein the application comprises from about 0.1 gal/A to about 500 gal/A, or from about 0.1 gal/A to about 10 gal/A of the biofungicide composition.

24. The method of any one of claims 12 to 16, wherein the crop comprises corn, soybeans, forages, potatoes, tomatoes, trees, vines, citrus, nuts, sugar beets, fruits, vegetables, and/or woody crops.

25. The method of claim 16, wherein the crop yield is increased by at least about 5% or by at least about 15%.

26. The method of any one of claims 12 to 16, wherein the method reduces the amount of synthetic pesticide used in crop production by at least about 10% by weight, by at least about 25% by weight, or at least about 50% by weight.
